(19) United States
(12) Patent Application Publication
(10) Pub. No.: US 2012/0021377 A1
(43) Pub. Date: Jan. 26, 2012

(54) ELECTRIC IMPLANT TORQUE WRENCH

(76) Inventor: Chun-Leon CHEN, Chang-Hua City (TW)

(21) Appl. No.: 12/843,111

(22) Filed: Jul. 26, 2010

(51) Int. Cl. A61C 1/18; A61C 1/06

(52) U.S. Cl. 433/105

(57) ABSTRACT

An electric implant torque wrench includes a main unit, having a torque generating mechanism for outputting a torque and a control knob for adjusting and setting the torque, a handle having a flexible tube connected to the main unit for receiving the torque outputted by the main unit, and a clutch mechanism connected to the handle for receiving the torque outputted by the main unit for rotating a rotary tip to drive a dental implant into a patient's gum. The clutch mechanism stops the rotary tip from rotation when the torque outputted by the main unit reaches the value set by the control knob during installation of the dental implant.

### BACKGROUND OF THE INVENTION

1. Field of the Invention

The present invention relates to dental implant tools and more particularly, to an electric implant torque wrench, which allows adjustment of torque, facilitating accurate installation of an implant in the gum.

2. Description of the Related Art

Conventionally, dental implant surgery is to install an implant in a patient's gum, and then to fasten an abutment to the top side of the implant with a screw, and then install a crown in the abutment after the wound is healed.

Installation of an implant in a patient's gum is the basic step to success in a dental implant surgery. Only after an implant has been accurately installed, the succeeding steps can be started. Therefore, implant installation is the most important part in a dental implant surgery.

Conventionally, a dentist uses a handpiece to perform a dental implant surgery. The handpiece has an implanting tool connected thereto. During operation, the working tip of the implanting tool is inserted into a specifically configured inner hole, for example, hexagonal hole or star-shaped hole on the top side of the implant, and then rotated by a power from the handpiece to drive the implant into the patient's gum. Because a dentist cannot control the torque of the implanting tool of the handpiece used during a dental implant surgery, a dentist can simply visually check the installed position in the gum and then stop the implanting tool by experience. According to this conventional method, an implant may be installed in the gum excessively deep or the installation depth may be insufficient, resulting in a dental implant failure. Therefore, an improvement in this regard is necessary.

### SUMMARY OF THE INVENTION

The present invention has been accomplished under the circumstances in view. It is one object of the present invention to provide an electric implant torque wrench, which allows adjustment of torque, facilitating accurate installation of an implant in the gum.

To achieve this and other objects of the present invention, an electric implant torque wrench comprises a main unit, which comprises a torque generating mechanism mounted therein for outputting a torque and a control knob for adjusting and setting the torque; a handle, which is configured for grasping with the hand, having a flexible tube connected to the main unit for transmission of the torque outputted by the main unit to the handle; and a clutch mechanism, which is connected to the handle for receiving the torque outputted by the main unit for rotating a rotary tip that is insertable into a hole on a dental implant for driving the dental implant into a patient's gum. The clutch mechanism stops the rotary tip from rotation when the torque outputted by the main unit reaches the value set by the control knob during installation of the dental implant.

Because the output rotary torque of the main unit can be set by means of the control knob, a dentist can calculate, according to experience, the maximum torque required for enabling the dental implant to be completely driven into the gum. Thus, the clutch mechanism will be stopped from rotating the rotary bit automatically after the rotary bit drives the dental implant into the gum to a suitable depth, increasing the chance of installation success and avoiding improper dental installation depth.

### BRIEF DESCRIPTION OF THE DRAWINGS

FIG. 1 is an exploded view of an electric implant torque wrench in accordance with the present invention.

FIG. 2 is a schematic drawing of the present invention, showing the electric implant torque wrench operated and a dental implant driven into the gum.

FIG. 3 is a perspective exploded view of the clutch mechanism according to the present invention.

FIG. 4 is a sectional assembly view of the clutch mechanism according to the present invention.

### DETAILED DESCRIPTION OF THE PREFERRED EMBODIMENT

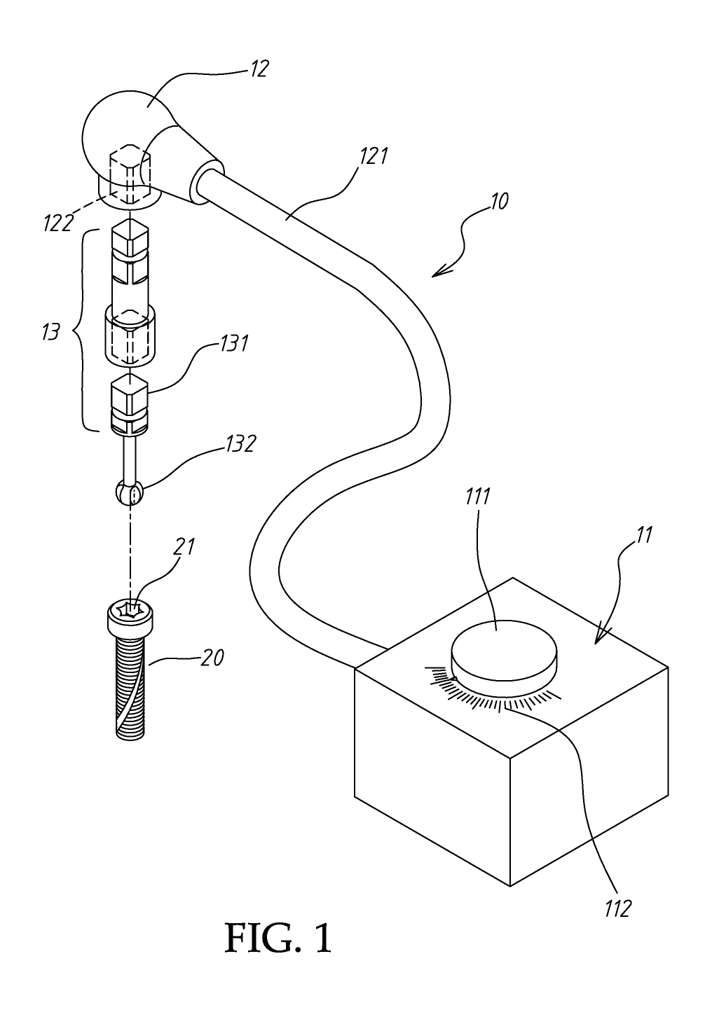

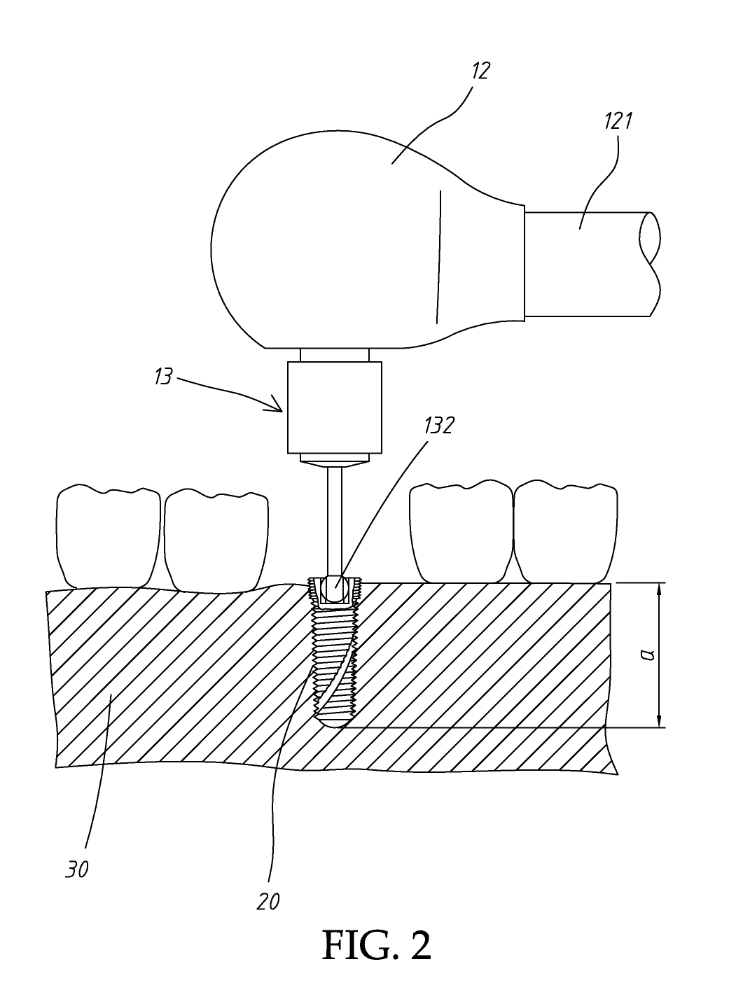

Referring to FIGS. 1 and 2, an electric implant torque wrench 10 in accordance with the present invention is shown for driving a dental implant 20 into a patient's gum 30 accurately. The electric implant torque wrench 10 comprises a main unit 11, a handle 12 and a clutch mechanism 13.

The main unit 11 has a torque generating mechanism (pneumatic or mechanical torque generating means, not shown) mounted therein for outputting a rotary torque, a control knob 111 mounted on the top side thereof, and graduations 112 marked on the top wall around the control knob 111. Subject to the indication of the graduations 112, the user can rotate the control knob 111 to adjust and set the rotary torque to be outputted.

The handle 12 is configured for grasping with the hand. According to the present preferred embodiment, the handle 12 has its front part shaped like a sphere and its rear part shaped like a tapered cylinder. Further, a flexible tube 121 extends from the rear side of the handle 12 and connected to the main unit 11 so that the rotary torque outputted by the main unit 11 can be transmitted to the inside of the handle 12.

The clutch mechanism 13 is connected to the handle 12 for receiving the rotary torque outputted by the main unit 11 for rotating a rotary bit 131. The rotary bit 131 has a working tip 132 for insertion into a specifically configured recessed hole 21 on the top side of the dental implant 20 to interfere with the inside wall of the recessed hole 21 for synchronous rotation.

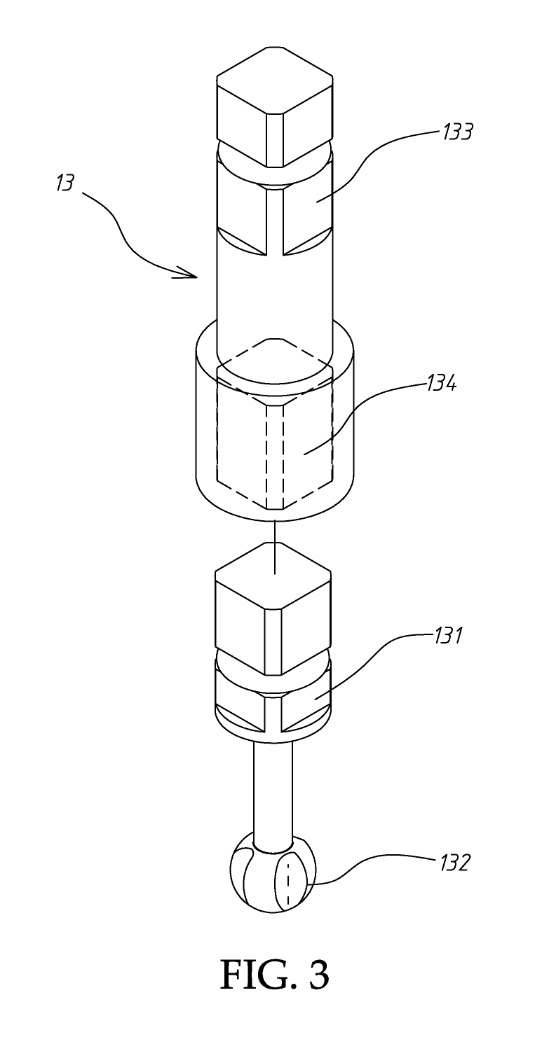

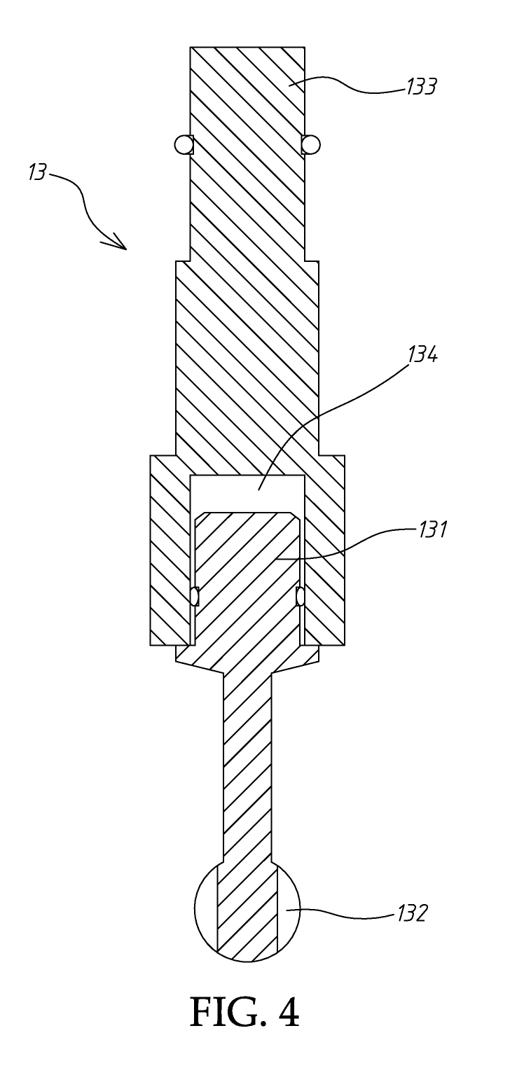

Referring to FIGS. 3 and 4, the clutch mechanism 13 has a rectangular shaft portion 133 located on the top side thereof and insertable into a rectangular hole 122 on the handle 12 for receiving the rotary torque outputted by the main unit 11, and a rectangular axle hole 134 located on the bottom side thereof for receiving the rotary bit 131 for synchronous rotation.

Rotating the rotary bit 131 of the clutch mechanism 13 can drive the dental implant 20 into the gum 30, as shown in FIG. 2. When the torque reaches the value set by the control knob 111 of the main unit 11, the clutch mechanism 13 stops the rotary bit 131 from rotation, finishing the installation of the dental implant 20 in the gum 30.

Because the output rotary torque of the main unit 11 can be set by means of the control knob 111, a dentist can calculate, according to experience, the maximum torque required for enabling the dental implant 20 to be completely driven into the gum 30. Thus, the clutch mechanism 13 will be stopped from rotating the rotary bit 131 automatically after the rotary bit 131 drives the dental implant 20 into the gum 30 to a suitable depth (see “a” in FIG. 2), increasing the chance of installation success and avoiding improper dental installation depth.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electric rotary torque wrench for dental implant surgery, comprising:
a main unit, said main unit comprising a torque generating mechanism mounted therein for outputting a torque and a control knob for adjusting and setting the torque;
a handle configured for grasping with the hand, said handle having a flexible tube connected to said main unit for transmission of the torque outputted by said main unit to said handle; and
a clutch mechanism connected to said handle for receiving the torque outputted by said main unit for rotating a rotary tip that is insertable into a hole on a dental implant for driving said dental implant into a patient's gum;
wherein said clutch mechanism stops said rotary tip from rotation when the torque outputted by said main unit reaches the value set by said control knob during installation of said dental implant.

2. The electric rotary torque wrench as claimed in claim 1, wherein said handle has a rectangular hole defined therein; said clutch mechanism comprises a rectangular shaft portion located on a top side thereof and fitted into the rectangular hole of said handle and a rectangular axle hole located on a bottom side thereof for receiving said rotary bit for synchronous rotation.
